(19) United States
(12) Patent Application Publication
(10) Pub. No.: US 2011/0223285 A1
(43) Pub. Date: Sep. 15, 2011

(54) METHOD FOR CONTROLLING PRODUCT CHARACTERISTICS IN THE MANUFACTURE OF MEAT PRODUCTS

(75) Inventors: Volker Heinz, Quakenbruck (DE); Fritz Kortschack, Berlin (DE)

(73) Assignees: Deutsches Institut for Lebensmitteltechnik e.V., Quakenbruck (DE); Triton GmbH, Berlin (DE)

(21) Appl. No.: 12/737,882

(22) PCT Filed: Sep. 2, 2009
(86) PCT No.: PCT/EP2009/061362

§ 371 Date: May 16, 2011

(30) Foreign Application Priority Data
Sep. 3, 2008 (DE) 10 2008 045 666.7
Sep. 25, 2008 (DE) 10 2008 048 543.8

(51) Int. Cl. A23L 1/317; A23L 1/314

(52) U.S. Cl. 426/58

(57) ABSTRACT

The invention relates to a method for controlling the product characteristics during the production of foodstuffs, which are attributable to the product groups raw and cooked sausages, pies, cooked meat products or the like, especially to obtain a spreadable or cuttable product. According to the invention, during the production of raw sausage usual starting materials are salted, mixed and coarsely pre-minced, however, not in a deep-frozen state. Then this mixture is subjected to a fermentation and acidification. According to the invention, a high-pressure treatment is performed subsequently so as to allow a protein coagulation and simultaneously inactivate microorganisms, while the mechanically separated raw meat materials remain separated. Then a fine mincing and a filling are performed.

During the production of cooked sausage usual starting materials are used, however, are processed in a non-heated state, that is, salted, mixed and coarsely pre-minced. This mixture is then subjected to a high-pressure treatment so as to predetermine the later consistency of the end product by means of the pressure intensity and the treatment period and, thus, by the extent of the protein denaturation, wherein the recipe mixture subsequently minced to the final grain size is filled into a sales envelope and is subjected to a second high-pressure treatment so as to prevent fat and gel sediments in the product and maintain the spreadability of the product over a long period.

The invention relates to a method for controlling the product characteristics during the production of foodstuffs, which are attributable to the product groups raw and cooked sausages, pies, cooked meat products or the like, especially to obtain a spreadable or cuttable product, according to the preamble of patent claim 1.

A method for producing stable meat and sausage products produced in the presence of microorganisms is already known from EP 0 944 329 B1.

The object of this teaching resides in providing a method according to which fabrication steps of the raw and dry sausage production can be performed in a simple and reliable manner and by means of which a qualitatively stable end product is obtained.

The prior method relates to subjecting the provided semi-finished products to a high-pressure treatment for several minutes at room temperature after a desired final pH-value was obtained, for maintaining it, and to processing them further in the usual manner. The high-pressure treatment is to deliberately interrupt the activities of the microflora in the semi-finished product. Thus, no relevant biochemical processes take place any longer.

The cooked sausage production technology is characterized by the fact that the production particularly of types of blood sausage has to be performed as hot as possible. Also the used bits of meat and/or bacon material have to be scalded at boiling temperatures and are processed further as hot as possible. Also, it is of great importance that the sausages are cooked without a temperature drop during the entire cooking time. Cooling, e.g. by adding cold water, even if the temperature is too high, has a shock-like effect on the core temperature especially of blood sausages and results in too soft a core with red-colored bacon bits in the finished product.

In the production of raw sausage types a difference is made between cuttable and spreadable raw sausage products. Other differentiations are required in these production methods as, for example, also the grain size both of cuttable and spreadable raw sausages requires a special technology. Basically, the meat material for a cuttable raw sausage has to be deep-frozen prior to the actual sausage production. The further treatment of the meat material prior to the actual raw sausage production then consists in mincing the deep-frozen meat blocks. Depending on the size of the cutter the deep-frozen pieces must have approximately the size of a fist so as to allow the cutter knives to take hold of and mince the frozen material. Also, the meat and bacon material used for the production of spreadable raw sausage types should only be processed in a well cooled state. In the hotter season it is even recommendable to slightly freeze the raw material. In any case, it has to be made sure that the meat does not already become doughy in the mincer as it might then rather be squeezed than cut.

It appears from the foregoing that the production of raw and cooked sausages requires technologically very complicated steps, which cannot be unified for various types of sausages without problems.

Therefore, it is the object of the invention to provide a further developed method for controlling the product characteristics during the production of foodstuffs, which are attributable to the product groups raw and cooked sausages, pies, cooked meat products or the like, especially to obtain a spreadable or cuttable product, said method guaranteeing a very high food safety and long lasting good qualities.

The solution to the object of the invention is achieved with a method according to the teaching of patent claim 1. The dependent claims define at least useful embodiments and further developments.

Accordingly, the method for controlling the product characteristics during the production of raw sausages is based on the use of usual starting materials. However, these materials are salted, mixed and coarsely minced not in a deep-frozen state, but at room temperature. This mixture is then subjected to fermentation and acidification, that is, to an intended reduction of the pH-value. According to the invention, a high-pressure treatment is performed subsequently so as to allow a protein coagulation and inactivate microorganisms, while the mechanically separated raw meat materials remain separated. Moreover, after these treatment steps, a fine mincing is performed. In this case, the high-pressure treatment can be regarded as a part of the fabrication steps.

In one embodiment of the production of raw sausages the filled product may be subjected to another, second high-pressure treatment.

Here, it is possible that fat be added during the mincing to the final grain size, whereupon the second high-pressure treatment is performed subsequently.

According to an alternative inventive approach to the solution it is provided not to subject the coarsely pre-minced raw materials used for the production of spreadable raw sausage to a high-pressure treatment after the reduction of the pH-value and prior to the mincing. A protein denaturation is already caused by the acidification, which ensures that the portions of lean meat no longer coalesce after the mincing to the final grain size.

However, this approach to the solution requires that a complete and steady denaturation of the proteins is ensured. After such a treatment the sausage meat, which was minced to the final grain size, can be introduced into the provided envelope and treated with high pressure for stabilization purposes (inactivation of microorganisms). In order to stabilize or maintain the color, which fades as a result of the high-pressure treatment, the fine mincing can be performed with the addition of CO₂.

During the production of cooked sausage, too, the usual starting materials are salted, mixed and coarsely pre-minced, however, not in a heated state. This mixture is then subjected to a high-pressure treatment so as to predetermine the later consistency of the end product by means of the pressure intensity and the treatment period and, thus, by the extent of the protein denaturation.

Subsequent to this treatment step the recipe mixture is minced to the final grain size and is filled into a sales envelope or packaging. This may be followed by a second high-pressure treatment so as to prevent fat and jelly sediments in the product, regardless of the raw material composition, and to maintain the spreadability of the product.

During the production of cooked sausage the product may also be filled into a water-permeable skin or a corresponding envelope. Even with such a filling material constellation the product remains spreadable for a longer period as compared to the prior drying technique.

To obtain a relatively solid consistency it is alternatively provided by the inventive teaching used for the production of cooked sausage products, pies etc. to bring the ready-made mixtures of raw material, salt and spices to a final grain size without a preceding high-pressure treatment in order to stabilize the reddened mixture by means of a high-pressure treatment after it has been filled into the provided envelopes.

According to another inventive thought relating to the production of cooked meat products, e.g. cooked ham, roast pork, smoked pork chops etc., the corresponding raw materials are initially trimmed and optionally flavored or salted afterwards, and this raw material is subjected to a high-pressure treatment so as to predetermine the later consistency of the end product by means of the pressure intensity and the treatment period and, thus, by the extent of the protein denaturation. The end product is then introduced into an ultimate consumer packaging, whereby the end product can, in this state, be subjected to another optional pressure treatment.

Moreover, a method for producing cooked cured products may include an initial flavoring step and the subsequent shape stabilization by means of short freezing, cutting into slices and packaging the individual slices.

The slices located in the packaging may slowly be tempered and subsequently be subjected to a high-pressure treatment. Also, it is possible to perform the high-pressure treatment first and to temper the cooked cured product afterwards.

According to an alternative inventive method the raw material (for cooked cured products) is first flavored and then filled into a shaping envelope. The so packed raw material is subjected to a high-pressure treatment at, for example, 6000 bar for a period of 3 minutes. The treated material may be provided with a stable shape by briefly freezing it. Then it is sliced and tempered. The tempering is performed, for example, at more than 55° C. and may be accomplished in the packaging line. Then, a second high-pressure treatment may be performed.

Due to this procedure a significantly lower thermal energy is required to obtain the temperature ranges, which are equally reduced in respect of their degree value.

Furthermore, the previous clear loss of color of cooked cured products, cooked ham, smoked pork chops, marinated products etc. is reduced by suitable measures such as increasing the pH-value. Also, the degree of tenderness is increased.

The inventive high-pressure treatment of fresh and marinated poultry meat results in a considerable sterilization and, thus, in an increased shelf-life of the products. A high-pressure treatment of marinated turkey filets at a pressure of 600 MPa for a period of 5 minutes leads, for example, to a prolongation of the shelf-life from approximately 10 days to at least 28 days.

In addition to the desirable sterilization, the denaturation, association, aggregation or gelling of proteins may be caused by structure or conformation changes, respectively. In general, the protein changes are influenced by the following parameters: pH-value, ion concentration, temperature and time of pressure treatment, protein concentration and storage conditions. High-pressure-induced protein changes can influence substantial functional and qualitative characteristics of the meat products, inter alia, the shearing force, the possibility of immobilizing water and the color.

According to the invention a high-pressure treatment of marinated poultry meat increases the water retention capacity. Especially in the case of acidified starting materials a reduction can be observed in comparison with native samples, while it is reduced in basic-marinated samples. Accordingly, the pH-value has an essential influence on high-pressure-induced changes of the product characteristics.

An adaptation of the marinade composition offers the possibility to avoid or minimize undesired reactions. Moreover, it be noted that an increase of the pH-value does not lead to a reduction of the shelf-life of the raw material to be treated.

If a reduction of the cutting capacity is initially obtained by marinating meat, an increase of the cutting capacity can be obtained by a high-pressure treatment of acid-marinated raw materials.

Moreover, it is provided by the inventive teaching to obtain a change in color by treating marinated meat with high pressure. Basic-marinated pieces of meat show, in this connection, the smallest change in color, which generally becomes brighter by the high-pressure treatment.

The inventive production of jellied meats using high pressure is performed as follows:

Reddened and possibly flavored raw or only slightly heated (approximately 55° C.) meat, tongues etc. are introduced into a container with the addition of other optional products such as vegetables, mushrooms etc. The bottom of the container is usefully already provided with an infusion capable of gelling. The infusion may be warm or cold.

The container is filled step by step with the products and gelling material, e.g. aspic, is sealed in an air-tight manner and advanced to the high-pressure treatment, if possible after the infusion mixture has cooled down. The product treated in the hermetically sealed envelope is then ready for sale. The high-pressure treatment applied during the production of jellied meats contributes to obtaining the color stability and increased tenderness of the added meat.

Moreover, the inventive teaching provides for an application of the high-pressure treatment during the production of ready-to-eat products such as burgers, cevapcici etc. The raw materials are flavored, salted and, possibly with the addition of roast flavors, mixed, minced, shaped and, depending on the product, provided with a coating. If required, the surface may be colored or also provided with a crust by means of a browning preparation and/or thermal treatment. The so treated raw materials are exposed to the high pressure in an air-tight envelope, which is partially stable with respect to its shape, if possible. After this treatment the product is stable with respect to its shape and is ready-to-eat.

Products such as escalopes, chicken wings etc., once they are flavored and salted, may be exposed to the high pressure in the packaging so that, similar to the thermally treated products, such products are stable with respect to their shape and have similar ready-to-eat characteristics, possibly by the addition of roast flavors to the coating, as the thermally treated goods available in the market.

Below, the invention shall be explained in more detail by means of an embodiment.

As was described above, a basic thought of the invention resides, inter alia, in preserving the spreadability of the end product for a long period by means of a special high-pressure treatment of the raw material or raw material mixture which is still to be minced to its final grain size.

During the production of spreadable raw sausage the raw material is coarsely pre-minced and provided with salt, spices and possible starter cultures.

Next, the desired reddening, acidification and fermentation take place at appropriate temperatures, e.g. approximately 18° C. over a period of approximately 24 hours.

This matured, fermented mixture is then subjected to a high-pressure treatment. Possible are pressure ranges of up to 6000 bar and more with an exposure time of substantially 3 minutes. This high-pressure treatment then leads to the desired protein coagulation.

After the high-pressure treatment was carried out, the correspondingly treated raw materials are brought to the final grain size, namely according to the target products to be obtained for smoked fine sausage spread, smoked coarse sausage spread, onion sausage, braunschweiger etc. In this sense, a filling into skins, cups or other suitable cases takes place.

If air-permeable skins are employed, e.g. for smoked sausage spread or braunschweiger, a smoking step may then be realized.

According to one embodiment it is possible to treat the end products with high pressure again, so as to preclude any undesired influences caused by a possible recontamination after the first high-pressure treatment.

Apart from the spreadability of the end product for a longer time, an advantage of the method described is the complete inactivation of microorganisms, wherein the pH-value remains constant over a long period.

At this point it should be mentioned that, according to the teaching of the main claim, a differentiation is made between two products, namely raw sausages and cooked sausages. If raw sausages are concerned, the pH- and the aw-value are to be reduced and a fermentation is to be performed. Cooked sausages obtain their product-specific characteristics primarily by a sufficient coagulation of the proteins.

According to another embodiment of the production of spreadable sausage having the product characteristics of raw sausage, a raw material is salted, which is as lean as possible, that is, which is not provided with bacon.

Instead of nitrite curing salt also common salt may be used, as possibly existing microorganisms are reliably inactivated by the subsequent high-pressure treatment.

If necessary, sugar is added for the pH-value reduction by microorganisms. Also, starter cultures or GDL may be added.

Of course, it is possible to add spices to the premix or during the final mincing.

The raw material mixture is then coarsely pre-minced and subsequently tempered, so that the reddening (only if nitrite curing salt is used) or the fermentation and acidification may take place during the storage.

If no water-absorbing substances are added to reduce the aw-value, the required drying takes place during the storage in appropriate rooms.

As the reddening, fermentation and pH-value reduction phase is exclusively performed with lean raw meat material, the aw-value is higher as compared to the total mixture, which supports a faster maturation and pH-value reduction. Additionally, the higher starting water content of the raw materials facilitates the necessary drying.

The fermented and pH-value-reduced raw material is then subjected to a high-pressure treatment, with or without the addition of the pure fat portions, so as to obtain a coagulation of the protein and an inactivation of microorganisms.

This treatment results in a direct slight increase of the pH-value, which then remains constant over a longer period and coagulates the protein.

By means of these method steps the individual, mechanically separated pieces of meat remain separated during the subsequent production steps and the storage. Thus, the product remains spreadable for a very long time.

If the product to be filled at a later time is subjected to a second high-pressure treatment so as to inactivate microorganisms that are formed in the sausage meat during the production process (mincing and filling), it is recommendable to add fat (bacon) only during the mincing to the final grain size.

The above-mentioned approach has the advantage that the mincing of the meat is steadier because the high-pressure treatment makes the fat more supple.

The recipe components minced to the final grain size are then filled into provided envelopes.

Even in a water-permeable skin the product remains spreadable for a long time. Air- and water-impermeable packagings, into which the minced material is filled, may be subjected to an additional supplementary high-pressure treatment so as to increase the product safety and shelf-life.

Spreadable or cuttable sausages or pies having the product characteristics of cooked sausage are realized in accordance with the example described below.

The raw materials are coarsely pre-minced and then mixed with salt—the use of common salt is possible as well—and spices.

If nitrite curing salt is used, an intermediate storage of the mixture is necessary for a durable coloring, i.e. reddening. Due to the formation of carcinogenic substances it is an advantage, however, to do without the use of curing salts. This may be readily realized by the use of the high-pressure treatment because this treatment has a similarly preserving effect as the use of nitrites, but without any generation of carcinogenic substances which are detrimental to health.

If one raw material component is liver, it may be added to the total mixture. However, it is also possible to process it separately, possibly at slaughter temperature.

Usually, cooked sausage is produced from fatty and lean meat, with the addition of specific products, e.g. liver or blood.

Advantageously, portions of lean meat are grown in.

The prepared raw materials are then subjected to a high-pressure treatment. The later consistency of the end product can be deliberately influenced by the intensity and the exposure time of the high pressure.

The adjustment possibilities pressure intensity and exposure time make it possible to fulfill the most different requirements in view of the consistency of the respective end product, that is, from spreadable to cuttable.

The lower the pressure is and the shorter the exposure times are chosen, the smaller is the degree of the desired protein denaturation.

A supplementary modification is the addition of liver, which may be at slaughter temperature, or pretreated raw meat to the already pressure-treated raw materials during the final mincing process.

For reasons of food safety it is, in this case, required to subject the correspondingly filled final packages to a high-pressure treatment once more. Cuttable products may require the high-pressure treatment only after the final mincing and mixing phase.

As was stated in the introductory part of the specification the standard raw material preparation process for cooked sausage products requires heating of the recipe components. During this heating meat protein, moisture and other ingredients, also vitamins, get lost.

To compensate the loss of moisture, a so-called broth is added during the final mincing. To avoid faulty products as a result of too high a microbial load a subsequent new pasteurization of the end products according to the prior art is common practice.

The raw material treatment for cooked sausages by means of high pressure allows a production without the loss of vitamins, meat protein, spices, salt or moisture. An addition of external water is not necessary. Therefore, the production is environmentally friendly, and there is no need for the disposal of wastes which are difficult to degrade.

The filling operation during the production of cooked sausage initially requires a mincing of the recipe mixture to the final grain size. The minced mixture is then filled into provided envelopes and once more treated with high pressure.

By means of this additional high-pressure treatment the fat sediment, which can often be seen in the end product, is prevented.

By using the above-introduced method the product remains spreadable for a substantially longer time, even in a water-permeable skin, than had previously been possible due to the drying.

Finally, it be noted that the cut presentation surfaces, as are offered, for example, at the sales counter, of the end products treated with high pressure show a smaller degree of desiccation.

1. Method for controlling the product characteristics during the production of foodstuffs, which are attributable to the product groups raw and cooked sausages, pies, cooked meat products or the like, especially to obtain a spreadable or cuttable product,
characterized in that
during the production of raw sausage usual starting materials are salted, mixed and coarsely pre-minced, however, not in a deep-frozen state, and this mixture is subjected to a fermentation and acidification, that is, pH-value reduction,
a high-pressure treatment is performed subsequently so as to allow a protein coagulation and inactivate microorganisms, while the mechanically separated raw meat materials remain separated, and further a fine mincing is performed after the high-pressure treatment step,
during the production of cooked sausage usual starting materials are salted, mixed and coarsely pre-minced in a non-heated state and this mixture is subjected to a high-pressure treatment so as to predetermine the later consistency of the end product by means of the pressure intensity and the treatment period and, thus, by the extent of the protein denaturation, wherein the recipe mixture subsequently minced to the final grain size is filled into a sales envelope and is subjected to a second high-pressure treatment so as to prevent fat sediments in the product and maintain the spreadability of the product.

2. Method according to claim 1,
characterized in that
during the production of the raw sausage the filled product is subjected to another high-pressure treatment.

3. Method according to claim 2
characterized in that
fat is added during the mincing to the final grain size and the second high-pressure treatment is performed subsequently.

4. Method according to claim 1,
characterized in that
during the production of cooked sausage the product is filled into a water-permeable skin or water-permeable envelope.
